(19) United States
(12) Patent Application Publication
(10) Pub. No.: US 2009/0011796 A1
(43) Pub. Date: Jan. 8, 2009

(54) MOBILE HANDSET SECURITY SYSTEM

(75) Inventor: Richard Ormson, Berkshire (GB)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/816,031

(22) PCT Filed: Feb. 23, 2006
(86) PCT No.: PCT/JP2006/303926

§ 371 Date: Aug. 10, 2007

(30) Foreign Application Priority Data
Feb. 23, 2005 (GB) 0503734.6

(51) Int. Cl. H04B 1/38

(52) U.S. Cl. 455/565

(57) ABSTRACT

A system and method if provided for controlling an electronic device, the system comprising means associated with a master electronic device for storing at least one identifier associated with a slave electronic capable of being linked to the master device and means for controlling the operation of one of the electronic devices in dependence on detection of the master device and at least one slave device being linked when operation of that device is to take place. The system is advantageously used for a mobile telephone handset security system.

### TECHNICAL FIELD

This invention relates to an improved system and method for providing security in relation to mobile telephone handsets.

### BACKGROUND ART

There is currently significant interest in improving the security mechanisms implemented in mobile communication devices. Firstly, following significant recent increases in some types of street crime, the UK government has launched a street crime initiative. One of the elements of this initiative is to reduce mobile phone theft by making stolen mobile phones useless to thieves by rendering them unusable.

Moreover, the operators of mobile communications networks are also interested in reducing revenue loss due to the theft of subsidized handsets.

Currently much of the development has been making handset architecture and locks more secure, but as yet little consideration has been given to the development of new security mechanisms.

Modern mobile communications handsets are increasingly being used with peripheral devices such as headsets for use with the mobile communication device while driving. The introduction of Bluetooth™, a system offered by Bluetooth Sig, Inc., and videophones has also increased the use of handsets with headsets and other peripheral devices.

### DISCLOSURE OF INVENTION

In accordance with the present invention there is provided both a method and a system for controlling an electronic device, the system comprising means associated with a master electronic device for storing at least one identifier associated with a slave electronic device capable of being linked to the master device and means for controlling the operation of one of the electronic devices in dependence on detection of the master device and at least one slave device being linked when operation of that device is to take place.

In accordance with one aspect of the invention, a plurality of sets of identifiers, each associated with a different combination of linked master and slave devices, is stored by the master device; operation of one of the electronic devices being controlled in dependence on detection of the master device being linked to at least one slave device corresponding to one of the plurality of sets of stored identifiers.

At least one of the sets of identifiers may include identifiers associated with two or more slave devices.

Although it is quite easy to steal a handset on its own, taking both the handset and all or some of its accessories is more difficult. The inventor has appreciated that as the number of accessories increases it is increasingly difficult for a thief to take both the handset and all or some of its accessories.

Preferred embodiments of the present invention seek to provide an alternative or additional security system to the conventional architecture and lock systems.

The security system need not be restricted to mobile communication devices and their associated accessories. Accordingly, the present invention can advantageously be applied to any electronic devices that are linked together.

### BRIEF DESCRIPTION OF DRAWING

An embodiment of the invention will now be described in detail by way of example with reference to the accompanying drawing in which:

FIG. 1 shows a block diagram of apparatus showing part of the mobile handset security system.

### BEST MODE FOR CARRYING OUT THE INVENTION

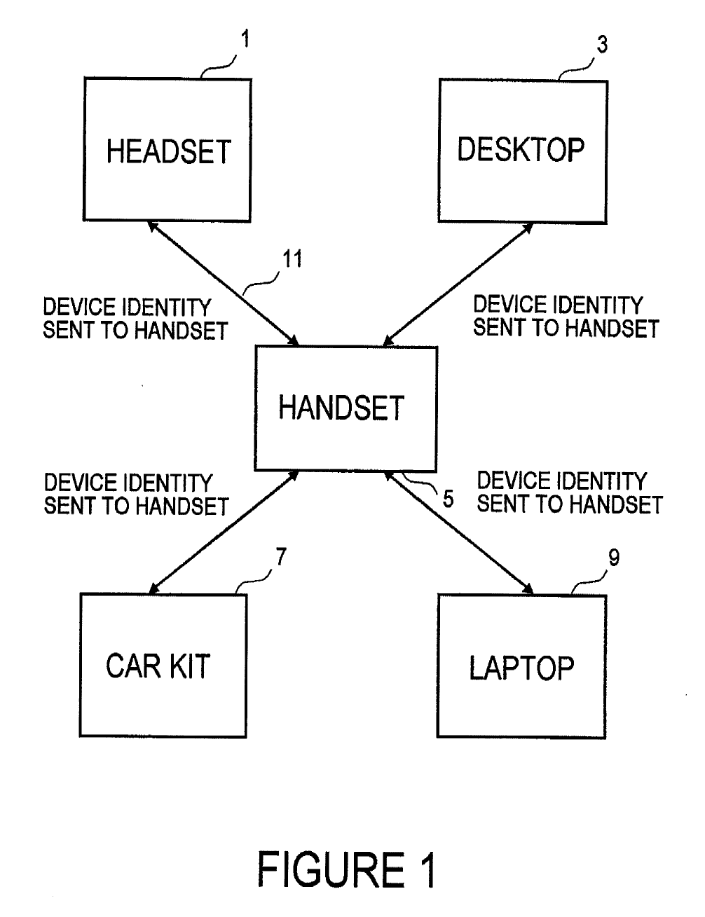

Referring to FIG. 1, there is shown a mobile handset security system comprising some but not necessarily all of the following components: a headset 1 and a desktop 3 which is part of a personal computer, both of which would be used at the home of the user, a wireless local area network 11 which is also located at the user's home, a hands free car kit 7 which is used in a car, and a laptop 9. Of course, other devices or networks could be used instead, for example, a local area network (LAN).

These devices can be connected to one another using any means, such as infra red or wireless means. In one embodiment the devices are connected using a cable means. However, the use of a cable is less satisfactory since it would require a user to physically connect the devices together and carry appropriate connecting wiring.

In a further embodiment a wireless network can be created for an individual user; a personal area network or PAN. This network ties all of a user's devices into one system. As new peripheral devices are invented, these can also be included in the PAN.

The handset has one or more realms or areas of operation in which the user has authorized or will authorize the use of specific combinations of devices. Such realms could for example be “at home”, “at work”, “in the car” or “elsewhere”. The realm shown in FIG. 1 could for example be the “at home” realm. In order to configure the system, the user has to attach the appropriate accessories in the usual way for each realm. Each of the devices connected by the user carries a unique identifier, so that as the devices are connected, a unique combination of identifiers is created for each realm. In one embodiment, this unique identifier could be the Universal unique Identifier (UUI) used by the Service Discovery Protocol (SPD) of Bluetooth™ devices. The SDP determines which services are available and their characteristics. The UUI is a hard-wired address identity, whose “uniqueness” is determined by the number of bits in the address.

Preferably, the mobile communication device is a master device and determines the combination of the identifiers of the other slave devices by an appropriate interrogation routine. If the detected combination of identifiers does not match that stored in the mobile communication device for one of the configured realms (or alternatively of for the configured realm), the device is rendered inoperative, except for emergency calls.

This embodiment has the advantage that if there is more than one realm, the transition between them does not require any action by the user, other than initially configuring the system to store the identifiers associated with the slave devices for each realm.

In a further embodiment, if a user were to move to an area that did not match any one of the defined realms, for example, if they forgot their headset, the security measures could be bypasses using a PIN code set by the authorized user. Entering the PIN code might, for example, allow the user to reconfigure that realm so that it is defined without the headset. The bypass security feature could also be made time dependent so that the PIN has to be re-entered after a period of inactivity.

After the initial configuration of the system, if the user wishes to add or remove devices in particular realms, this can be achieved in exactly the same way as the initial configuration procedure as long as the device is in a recognized realm. Alternatively, reconfiguration of the realms might require the entry a security PIN. Thus the PIN might only be required if the device is not in a recognized realm or, alternatively, whenever a realm is reconfigured.

The security system is configured so that as long as the current set of devices matches (at least) one of the realms defined by the user during set up, then the handset security restrictions are disabled.

In practice each realm may be defined simply by assigning one device uniquely to each realm so that that device identifies the realm in question. In the case of the home, the desktop 1 or wireless LAN 1 could be used to identify the at home realm. In the car, the car kit can be used to identify an “in car” realm.

Although an embodiment of the invention has been described with reference to mobile communication devices, it will be appreciated by those skilled in the art that the invention can advantageously be applied to any linked electronic devices, each with an identifier. Accordingly, any of these devices can be used to determine whether the current set of devices is an authorized combination of devices, and to limit the operation of one or more of these devices according to user defined preferences.

1. A system for controlling an electronic device, the system comprising:
means associated with a master electronic device for storing at least one identifier associated with a slave electronic device capable of being linked to the master device; and
means for controlling the operation of one of the electronic devices in dependence on detection of the master device and at least one slave device being linked when operation of that device is to take place.

2. A system according to claim 1 wherein a plurality of sets of identifiers, each associated with a different combination of linked master and slave devices, is stored by the master device; operation of one of the electronic devices being controlled in dependence on detection of the master device being linked to at least one slave device corresponding to one of the plurality of sets of stored identifiers.

3. A system according to claim 2 in which at least one of the sets of identifiers includes identifiers associated with two or more slave devices.

4. A system according to claim 1 in which at least some of the identifiers are Universal unique Identifiers defined by the service discovery protocol of the Bluetooth™ system.

5. A system according to claim 1 in which the master electronic device is a mobile communication device.

6. A system according to claim 5 in which the mobile communication device is a mobile telephone handset and the slave device or devices may be one or more of a headset, a hands free car kit, a computer desktop or a local area network to which the telephone handset may be linked.

7. A method of controlling an electronic device, in which at least one identifier associated with a slave electronic device capable of being linked thereto is stored by a master electronic device; and operation of one of the electronic devices is controlled in dependence on detection of the master device and at least one slave device being linked when operation of that device is to take place.

8. A method according to claim 7 wherein a plurality of sets of identifiers, each associated with a different combination of linked master and slave devices, is stored by the master device; operation of one of the electronic devices being controlled in dependence on detection of the master device being linked to at least one slave device corresponding to one of the plurality of sets of stored identifiers.

9. A method according to claim 8 in which at least one of the sets of identifiers includes identifiers associated with two or more slave devices.

10. A method according to any of claims 7-9 in which at least some of the identifiers are Universal Unique Identifiers defined by the service discovery protocol of the Bluetooth™ system.

11. A method according to any of claims 7-9 in which the master electronic device is a mobile communication device.

12. A method according to claim 11 in which the mobile communication device is a mobile telephone handset and the slave device or devices may be one or more of a headset, a hands free car kit, a computer desktop or a local area network to which the telephone handset may be linked.
